(19) United States
(12) Patent Application Publication
(10) Pub. No.: US 2012/0187685 A1
(43) Pub. Date: Jul. 26, 2012

(54) AIR DRIVEN ELECTRIC GENERATOR FOR CHARGING A BATTERY

(76) Inventors: Joseph Amin, Los Angeles, CA (US); Robert J. Netzel, SR., Simi Valley, CA (US); Sheldon Denst, Simi Valley, CA (US)

(21) Appl. No.: 13/011,935

(22) Filed: Jan. 24, 2011

(51) Int. Cl. F03D 9/02

(52) U.S. Cl. 290/50

(57) ABSTRACT

An air driven electric generator with cylindrical rotors with blades longitudinally across most of the rotor used to charge a battery. Each rotor is connected to a generator/alternator that generates electricity as the rotor is rotated by airflow or wind. The rotors are positioned on a base and underneath a cover that form inlet and outlet slots that direct the airflow or wind to the blades of the rotors. The airflow or wind push against the blades to rotate the rotor continuously. As the cylindrical rotors rotate, the generators/alternators generate positive flow of electricity which is used to recharge the batteries used in a vehicle, street light, traffic light, boat, airplane, or residence.

### BACKGROUND OF INVENTION

1. Field of Invention

The present invention relates to the fields of generation of electricity by force of wind and aerodynamics. More particularly, the present invention relates to an airflow driven electrical generator which provides increased efficiency and reduced drag for use in various applications, including a moving vehicle, a building, and street lights.

2. Description of Prior Art

In recent years, efficient and cost effective production of energy has become very important, especially for transportation. Conserving energy and achieving the maximum use of the energy available is critical in achieving this goal. In particular, in the field of transportation, increasing use of gasoline-powered vehicles significantly contributes to environmental pollution, noise, and depletion of crude oil reserves. As fossil fuel prices are rising, many states are mandating the production and sale of zero-emissions vehicles and other energy consuming devices. To meet these requirements, many manufacturers are experimenting with electricity generating devices. Electrically-powered vehicles are known to solve some of the problems associated with gasoline-powered vehicles, but such vehicles are not yet in widespread use. Electrically-powered vehicles have certain drawbacks as compared to vehicles powered by conventional gasoline engines and newer hybrid vehicles.

Significant drawbacks include limited travel range between battery recharging and excessive time required for recharging the batteries. The average travel distance between battery recharging for currently available electrically powered vehicles is considerably less than the travel distance achieved between gasoline refills of gasoline or hybrid powered vehicles. In addition, it usually takes several hours to recharge the batteries during which time the vehicle remains inoperable.

Much research is being conducted to develop the inexpensive recharging of the batteries used in various devices, especially in vehicles to extend their current limited ranges. Most advances have been made in the field of solar cells. Unfortunately, solar panels cannot capture enough energy from the sun to maintain sufficient power in non-sunny conditions thereby restricting the use of these devices to specific geographic areas and times of day. However, the abundance of wind energy flowing over a moving vehicle or other devices has remained unharnessed. Several devices that utilize the wind resistance to generate electrical power have been described in the prior art, but all have inherent limitations. The primary limitation being that the drag created by the wind-capturing devices has been greater than the electricity generated, resulting in a negative, rather than positive, electrical flow.

One such wind-capturing device is taught by U.S. Pat. No. 3,621,930 and uses propellers in an air tunnel with a Venturi. However, such propellers generate significant drag, and particularly at higher speeds, the drag can use more energy than is gained by the electrical generation system. More recently, U.S. Pat. No. 6,138,781 discloses a multi-stage impeller system which includes high-speed impellers and low-speed impellers for driving an electric generator/alternator for generating electricity in an electric vehicle. Although two different impeller blades are used in this device, it still produces significant drag.

Furthermore, U.S. Pat. No. 5,287,004 teaches rotors having horizontal axes and fixed blades running the length of the axes and extending symmetrically no more than a few inches from the axes, each blade being curved in the same direction. Two electric generators are attached to each rotor by short rods at both ends. Air current passing around the vehicle turns the rotors and generates electricity. Although, this '004 Patent is the closest prior art to the current invention that the inventor has been able to identify, it not only still produces significant drag, but it creates a non-continuous rotation of the generator thus reducing the efficiency of the recharging process.

Accordingly, there is still a need to develop more efficient ways to charge batteries by harnessing the wind.

### SUMMARY OF THE INVENTION

Accordingly, the present invention has been made in view of the above-mentioned disadvantages occurring in the prior art. The present invention is an air driven electricity generator to charge the batteries used in various devices, including, street lights, traffic lights, houses, automobiles, and more. The electricity generator of the present invention is driven by cylindrical rotors with blades that rotate continuously as flow of air pushes against the blades. The rotating cylindrical rotors are connected to generators/alternators that generate positive flow of electricity which is used to recharge the batteries used in vehicles and other devices.

It is therefore a primary object of the present invention to provide a device that harnesses the flow of air or wind to rotate multiple cylindrical rotors connected to alternators/generators that in turn create sufficient electricity to charge batteries used in various items, including an automobile.

Another object of the present invention is to provide continuous rotation of the cylindrical rotor so that the production of electricity is uninterrupted and efficient.

Yet another object of the present invention is to provide a method of directing the flow of air or wind across the top portion of the cylindrical rotors in an almost laminar flow thus minimizing the turbulent or drag producing air flow.

Yet another object of the present invention is to minimize the amount of drag created by capturing the wind so that the electricity generated does not result in a negative electrical flow.

A still further object is to use effective bearings to minimize the amount of rotational friction at the ends of the cylindrical rotors that reduce the rotational speed and torque generated by the rotors.

The above objects and other features and advantages of the present invention, as well as the structure and operation of various embodiments of the present invention, are described in detail below with reference to the accompanying drawings.

### DESCRIPTION OF THE DRAWINGS

The accompanying drawings which are incorporated by reference herein and form part of the specification, illustrate various embodiments of the present invention and, together with the description, further serve to explain the principles of the invention and to enable a person skilled in the pertinent art to make and use the invention. In the drawings, like reference numbers indicate identical or functional similar elements. A more complete appreciation of the invention and many of the attendant advantages thereof will be readily obtained as the same becomes better understood by reference to the following detailed description when considered in connection with the accompanying drawings, wherein:

FIG. 1 is a perspective view of the air driven electric generator of the present invention in its assembled state as it would be installed on the roof of a vehicle.

FIG. 2 is a drawing that depicts the various locations on a vehicle to which the air driven electric generator of the present invention may be attached.

FIG. 3 is a perspective view of the air driven electric generator of the present invention without the cover to show arrangement of the cylindrical rotors.

FIG. 4 is a perspective view of the cylindrical rotor to depict the spiral blades.

FIG. 5 is a perspective view of the fully assembled air driven electric generator.

FIG. 6 is a sectional view of the fully assembled air drive electric generator.

FIG. 7 is a drawing depicting the air driven electric generator of the present invention installed on a traffic light.

FIG. 8 is a drawing depicting the air driven electric generator of the present invention installed on a street light.

FIG. 9 is a drawing depicting the air driven electric generator of the present invention installed on a boat.

FIG. 10 is a drawing depicting the air driven electric generator of the present invention installed on a building.

FIG. 11 is a drawing depicting the air driven electric generator of the present invention installed on a wing of a plane.

FIG. 12 is a drawing depicting multiple air driven electric generators of the present invention with a single rotor and installed vertically on the roof of a building.

FIG. 13 is a drawing depicting the air driven electric generator of the present invention installed vertically on an open field or yard.

### DETAILED DESCRIPTION OF THE PREFERRED EMBODIMENTS

Reference will now be made to the drawings in which various elements of the present invention will be given numerical designations and in which the invention will be discussed so as to enable one skilled in the art and make use the invention.

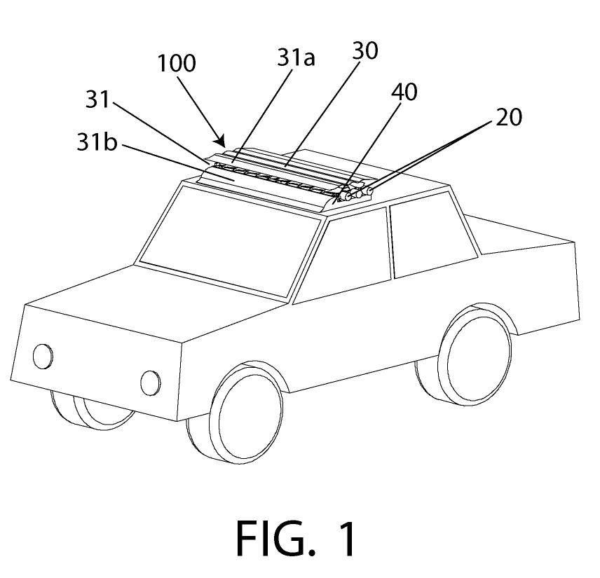

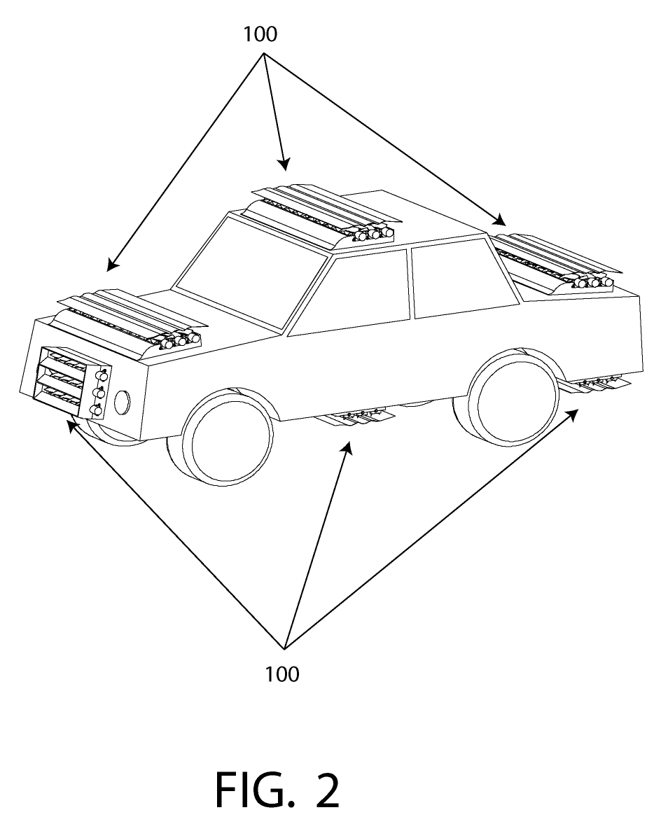

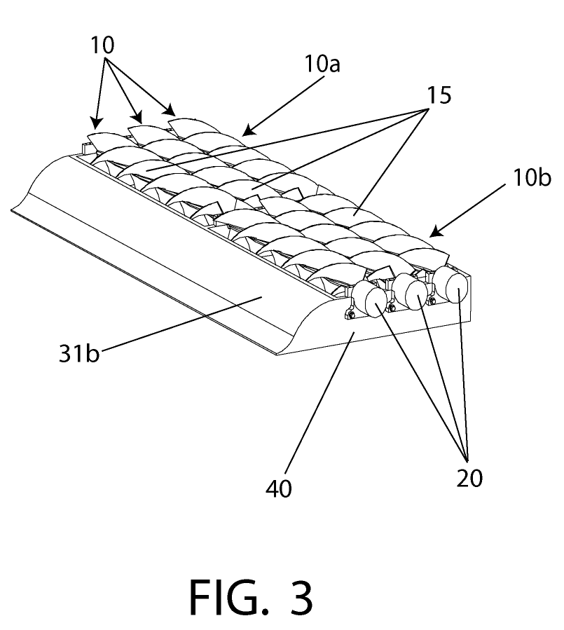

The air driven electric generator 100 of the present invention comprises of multiple cylindrical rotors 10. Although this air driven electric generator 100 can be used to charge the batteries in various devices, for the purpose of this patent, we focus on its use in a vehicle. Thus, the multiple cylindrical rotors 10 are arranged on a vehicle, preferably on the roof, as shown on FIG. 1. However, the electric generator 100 of the present invention can be arranged in the front, rear, top, or bottom of a vehicle, as shown in FIG. 2. Each cylindrical rotor 10 is made up of two half rotors 10a and 10b attached together rigidly. Due to the overall length of each cylindrical rotor 10 it is less expensive and easier to manufacture half rotors 10a and 10b. The air driven electric generator 100 of the present invention is driven by a single cylindrical rotor 10 or by multiple cylindrical rotors 10 arranged one behind the other as shown in FIG. 3.

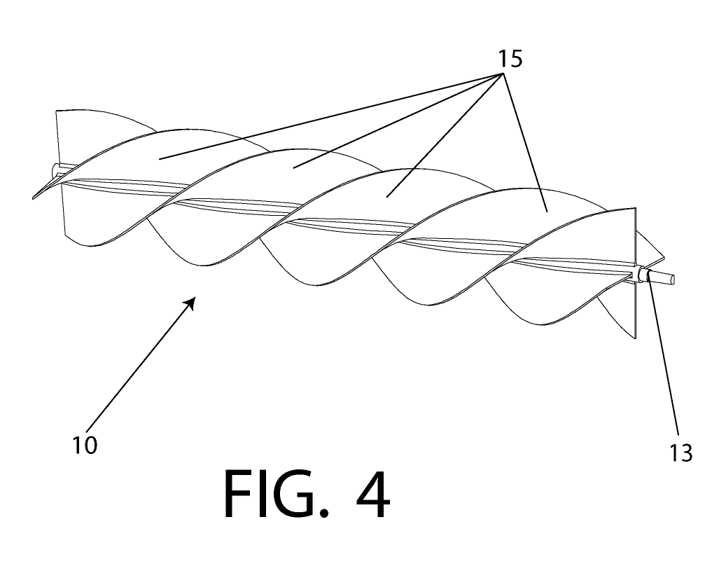

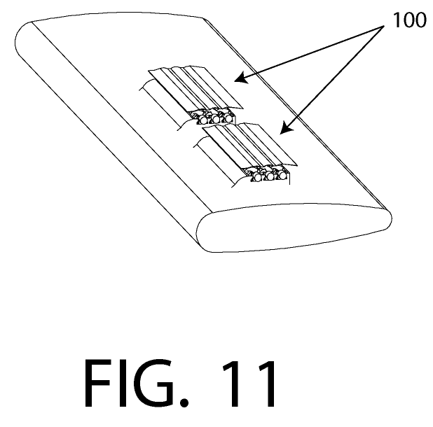

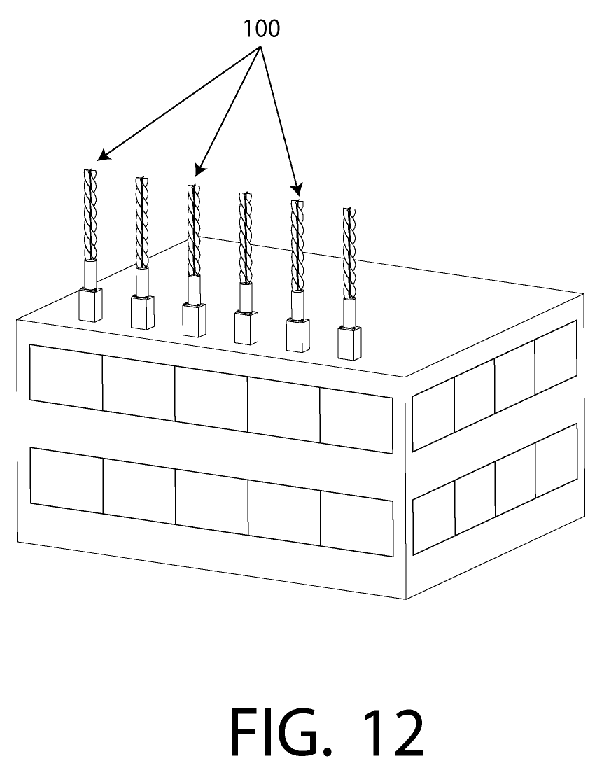

Each cylindrical rotor 10 extends horizontally much of the way across the width of the vehicle or it can extend vertically from the roof of a building, as shown in FIG. 11. Each cylindrical rotor 10 has at least one blade 15 the runs nearly the entire length of the cylindrical rotor 10 and extends radially outward a short distance. Each blade 15 spirals in a longitudinal direction across most of the cylindrical rotor 10, as shown in FIG. 4.

In the preferred embodiment, the cylindrical rotors 10 are arranged on the roof and across the width of a vehicle so that they are transverse to the flow of air or wind over the vehicle. Said airflow causes the cylindrical rotors 10 to rotate by impingement upon the spiral blades 15 with a minimum of drag on the vehicle.

A generator/alternator 20 of the appropriate voltage for the vehicle is attached to an end of the cylindrical rotors 10. In effect, the cylindrical rotor 10 replaces the flywheel of the generators/alternator 20. As the vehicle is driven at high speeds in the forward direction, the airflow running over the vehicle causes the cylindrical rotors 10 to rotate. As the cylindrical rotors 10 rotate, the generators/alternators 20 generate positive flow of electricity which is used to recharge the batteries used in the vehicle and other devices.

To minimize the amount of rotational friction that may inhibit the rotation of the cylindrical rotors 10, each end of the cylindrical rotors 10 is mounted on to a base 40 using a rotational bearing 35, such as ball bearings, that allows for reduced rotational friction forces exerted against the cylindrical rotors 10.

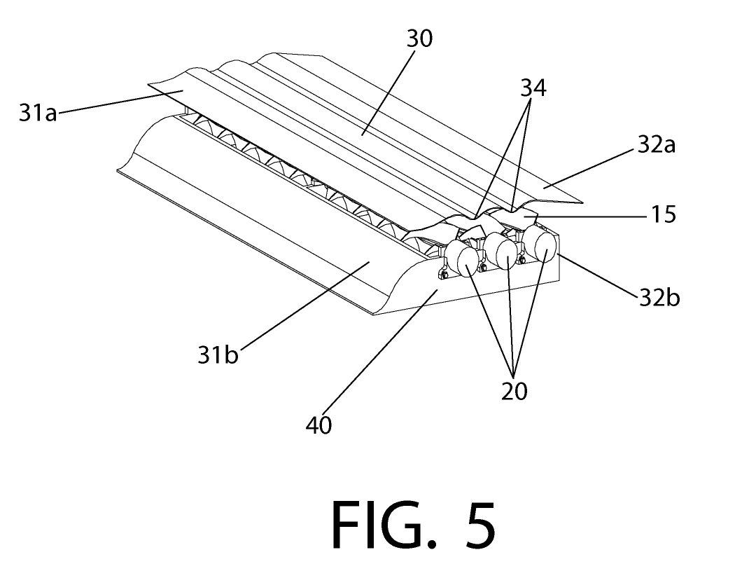

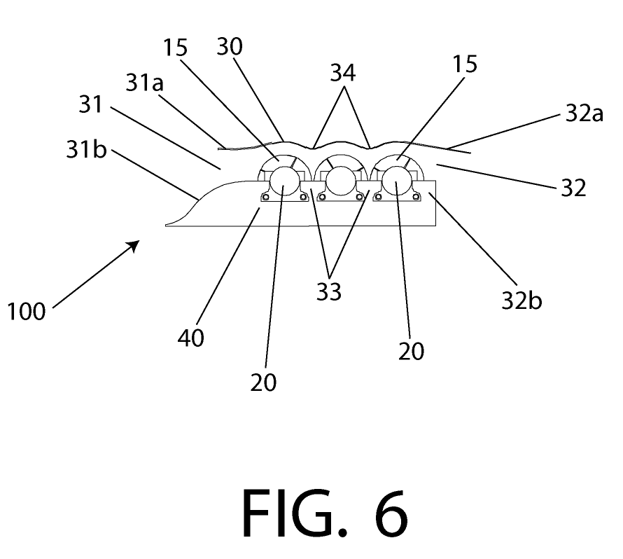

A cover 30 is attached to the base 40 and positioned over the cylindrical rotors 10 to protect them and to direct the airflow in a manner that maximizes their rotation, as shown in FIG. 5. The cover 30 and the base 40 form an air inlet slot 31 in the front and an air exit slot 32 in the rear. The air inlet slot 31 is designed to direct the airflow toward the top portion of the cylindrical rotors 10 for continuous rotation. Thus the airflow pushes against the sections of the spiral blades 15 that are extending upward. Immediately over the air inlet slot 31, the cover 30 has a surface 31a and immediately under the air inlet slot 31 the base has a surface 31b. Both of these surfaces 31a and 31b are designed to funnel the airflow directly into the air inlet slot 31, as shown in FIG. 6. On the other hand, the air exit slot 32 is designed in the rear of the cover with surfaces 32a and 32b designed to funnel the airflow out of the air driven electric generator 100 of the present invention, as shown in FIG. 6. In addition, surface 32b is positioned vertically to minimize the build-up of air turbulence or drag-producing air that may interfere with the rotation of the last cylindrical rotor 10. Furthermore, a vertically extending protrusion 33 with a height that can be adjusted up to the top of the cylindrical rotors 10 is placed behind each cylindrical rotor 10 so as to minimize the build-up of air turbulence or drag-producing air that may interfere with the rotation of the cylindrical rotors 10 and to direct the airflow toward the spiral blades 15 of the subsequent cylindrical rotor 10. The aerodynamics of every installation is different so the height of each vertically extending protrusions 33 must be adjusted for every installation to optimize the flow of air or wind over the cylindrical rotors 10.

As the air is funneled into the air inlet slot 31, it is directed to the spiral blades 15 of the first cylindrical rotor 10 extending upward so as to push against them and rotate the first cylindrical rotor 10. As the airflow moves past the first cylindrical rotor 10, the vertically extending protrusion 33 and the folds 34 in the cover 30 direct the airflow to the spiral blades 15 of the second cylindrical rotor 10 so as to rotate the second cylindrical rotor 10. After the last cylindrical rotor 10 in the air driven electric generator 100 of the present invention, the surfaces 32a and 32b funnel the airflow out. In effect, the configuration of surfaces, folds, and protrusions in the air driven electric generator 100 of the present invention minimize the amount of air turbulence and maintain the flow of air across the cylindrical rotors 10 as laminar as possible so as to maximize the rotational torque generated by the cylindrical rotors 10.

U.S. Pat. No. 5,287,004 teaches a wind powered electric generator for a vehicle where the blades of the rotor are longitudinally straight and do not spiral. With blades that do not spiral, the airflow rotates the rotor discontinuously. Once the first blade is pushed by the airflow, the rotational momentum of the rotor must be sufficient to bring the subsequent blade within the path of the airflow so that it may be pushed to keep the rotor turning Immediately after the first blade is pushed and before the second blade is brought within the path of the airflow, the air flow continues to pass over the rotor without exerting any type of rotational force. Thus, the rotational force exerted against the rotor is not continuous and not all of the potential energy from the airflow is harnessed.

However, in the air driven electric generator 100 of the present invention, the blades are spiral to allow a predetermined amount of surface area to always be within the path of the airflow. Thus, as the airflow pushes against a section of the spiral blade 15, the rotating cylindrical rotor 10 continuously brings up another section of a spiral blade 15 against which the airflow may continue to push for continuous rotation of the cylindrical rotor 10. The amount of surface area required to always be within the path of the airflow depends on the type of vehicle being used and the amount of torque required by the alternator/generator 20. The greater the torque requirement, the greater the surface area needed. Since the amount of torque required is dependent on the amount of electricity generated by the alternator/generator 20, the larger the battery, the more surface area is required.

It should be noted that U.S. Pat. No. 6,857,492 teaches a rotor with blades that spiral as in the present invention. However, the '492 Patent positions the longitude of the rotor parallel to the flow of air, not perpendicular as taught by the present invention. The '492 Patent fails to recognize that, although placing the rotor longitudinally parallel to the airflow allows for continuous rotation of the rotor, it increases the drag resistance on the vehicle. Placing the cylindrical rotor 10 perpendicular with the airflow may take up more space across the vehicle, but it reduces the amount of drag relative to the system described in the '492 Patent.

The cylindrical rotor 10 of the present invention must be slender in appearance to minimize the bulky nature of the device when installed in a vehicle. The cylindrical rotor 10 must be as light as possible yet strong enough to remain rigid when spun by forces of airflow greater than 100 miles per hour. The material used in the cylindrical rotor 10 must be weather resistant and must not conduct electricity. Thus, the recommended material for the cylindrical rotor 10 is a strong plastic such as glass-filled nylon. When designing the shape of the cylindrical rotor 10, the diameter of the center cylindrical shaft 13 should be minimized while the overall height of the spiral blades 15 should be maximized so as to minimize the overall weight of the cylindrical rotor 10 while maximizing the amount of surface area available for the airflow to push against at any given moment. Similarly, the amplitude of the spiral blades 15 should be long enough to maximize the amount of surface area exposed to the path of the airflow. It is important that the minimum required amount of surface area of the blade is always within the path of the airflow so as to never break the continuity of rotational force exerted against the cylindrical rotor 10.

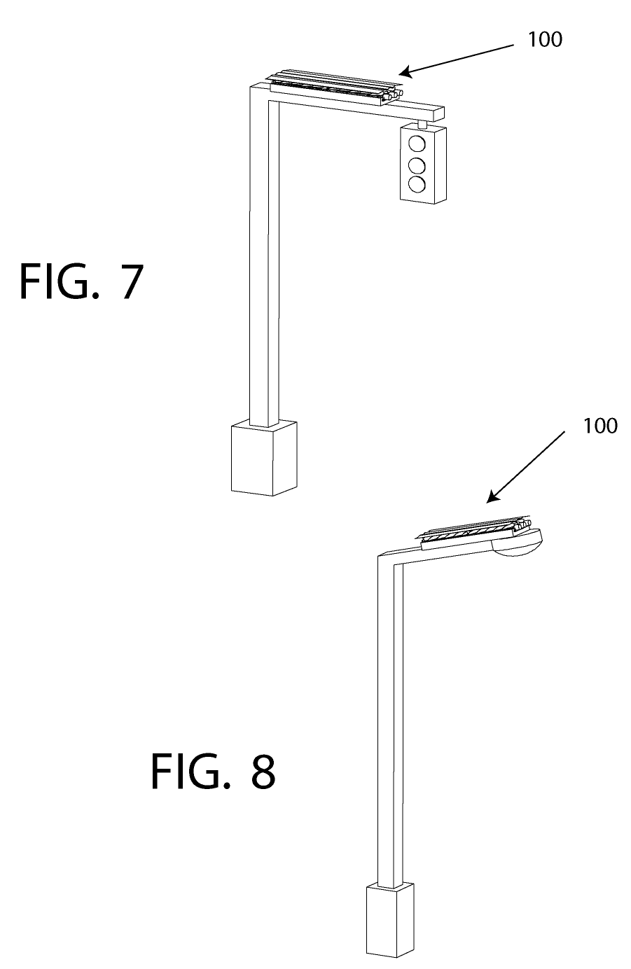

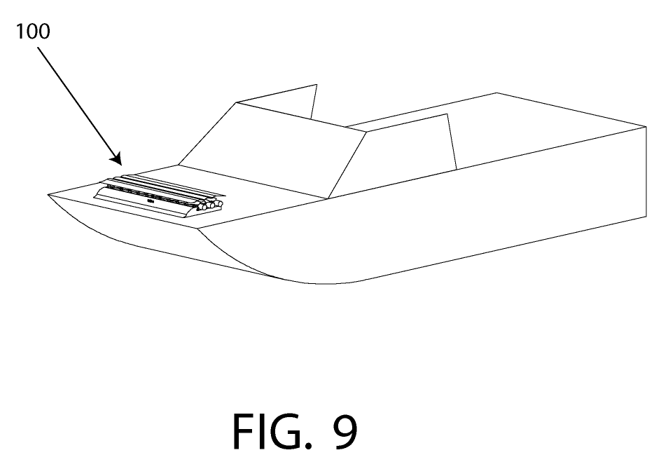

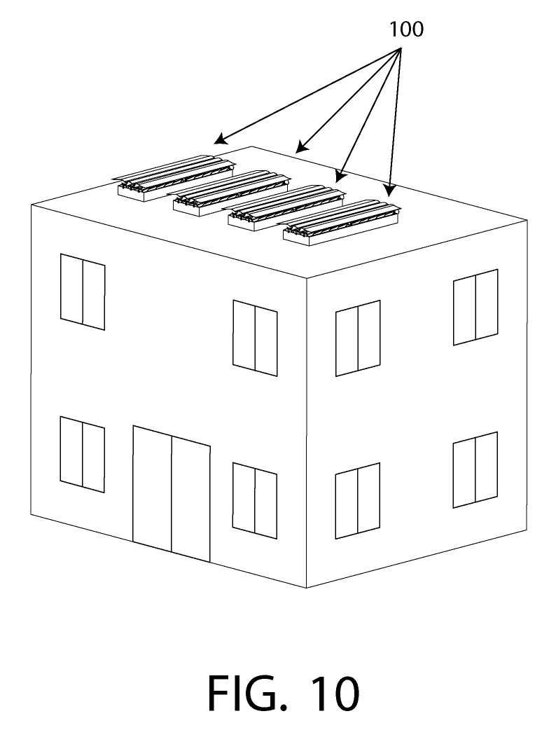

In effect, the air driven electric generator 100 of the present invention includes one or multiple cylindrical rotors 10 that are mounted on a base 40 and underneath a cover 30. The electric generator 100 has at least two wires 16 coming out. Installation involves mounting the air driven electric generator 100 on an energy consuming device. The wires 16 are directly connected to the main battery that supplies electric power to said device. As shown in FIGS. 7 to 13, the electric generator 100 can be installed horizontally or vertically on a vehicle, traffic light, street light, boat, building, airplane wing, or even an open field.

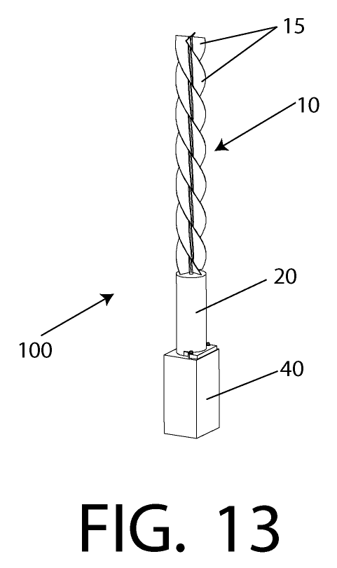

In an alternative embodiment, the air driven electric generator 100 of the present invention is driven by a single cylindrical rotor 10 attached to the generator/alternator 20 and installed vertically. The generator/alternator 20 is attached to the base 40 which provides support for the cylindrical rotor 10 to maintain its vertical position. The cylindrical rotor 10, when installed in the vertical direction, would not require a cover with air inlet and air outlet slots. Its position in the vertical position would allow the single cylindrical rotor 10 to be rotated by airflow or wind coming from any direction. This alternative embodiment would not be appropriate for installation on a moving vehicle. This alternative embodiment would be appropriate for installation on the roof of a building, as shown in FIG. 12, or on an open field or yard, as shown in FIG. 13.

In an another alternative embodiment, the air driven electric generator 100 of the present invention utilizes magnetic bearings at each end of the cylindrical rotors 10 to minimize the rotational friction that may inhibit the rotational torque generated by the rotation of the cylindrical rotors 10. The magnetic bearings are comprised of two spaced apart repelling pieces of magnetic material attached to each end of the cylindrical rotor 10 and to each mount 50 in which the cylindrical rotors 10 are attached, respectively. These magnetic bearings provide very low friction since parts are not in physical contact with each other.

In view of the above, the present invention may be embodied in other specific forms without departing from the spirit or essential attributes thereof and, accordingly, reference should be made to the appended claims, rather than to the foregoing specification as indicating the scope of the invention.

What is claimed is:

1. An apparatus for generating electricity comprising:
a generator for generating electricity;
a battery that is electrically connected to said generator and that is recharged by said electricity generated by said generator;
a cylindrical rotor having a longitudinal axis and a plurality of blades extending a few inches from said axis;
said blades being spirally shaped and running longitudinally in said cylindrical rotor;
said cylindrical rotor attached to said generator;
a base on which said cylindrical rotor is adapted to rotate about said axis;
a cover attached to said base without inhibiting the rotation of said cylindrical rotor;
an air inlet slot formed by said base and said cover to direct airflow or wind perpendicularly to less than all of said blades of said cylindrical rotor;
whereby said airflow or wind pushes against less than all of said blades to rotate said cylindrical rotor causing said generator to generate electricity that recharges said battery; and
an air outlet slot formed by said base and said cover to direct said airflow or wind out of said apparatus for generating electricity after it has gone past said cylindrical rotor.

2. An apparatus for generating electricity in accordance with claim 1 further comprising a plurality of said cylindrical rotors arranged parallel to each other on said base and perpendicular to said airflow or wind.

3. An apparatus for generating electricity in accordance with claim 1 wherein said cover is curved with folds to direct said airflow or wind over said cylindrical rotor to push against less than all of said blades.

4. An apparatus for generating electricity in accordance with claim 1 wherein said base has a vertically extending protrusion behind said cylindrical rotor having a height that can be adjusted to prevent the formation of drag-producing air.

5. An apparatus for generating electricity in accordance with claim 1 further comprising bearings that reduce friction during the rotation of said cylindrical rotor.

6. An apparatus for generating electricity in accordance with claim 1 wherein said cylindrical rotor is made of plastic.

7. An apparatus for generating electricity comprising:
a plurality of cylindrical rotors each having a longitudinal axis and a plurality of blades extending a few inches from said axis;
a plurality of generators for generating electricity each of which is connected to one of said cylindrical rotors;
a battery that is electrically connected to said generators and that is recharged by said electricity generated by said generators;
said blades being spirally shaped and running longitudinally in each of said cylindrical rotors;
a base on which each of said cylindrical rotors are adapted to rotate about said axis of each corresponding cylindrical rotor;
said base having a vertically extending protrusion behind each of said cylindrical rotors having a height that can be adjusted to prevent the formation of drag-producing air;
a cover attached to said base without inhibiting the rotation of said cylindrical rotors;
an air inlet slot formed by said base and said cover to direct airflow or wind perpendicularly to less than all of said blades of said cylindrical rotors;
whereby said airflow or wind pushes against less than all of said blades to rotate said cylindrical rotors causing said generators to generate electricity that recharges said battery; and
an air outlet slot formed by said base and said cover to direct said airflow or wind out of said apparatus for generating electricity after it has gone past said cylindrical rotors.

8. An apparatus for generating electricity in accordance with claim 7 wherein said cover is curved with folds that direct said airflow or wind over said cylindrical rotors to push against less than all of said blades.

9. An apparatus for generating electricity in accordance with claim 7 further comprising bearings that reduce friction during the rotation of said cylindrical rotor.

10. An apparatus for generating electricity in accordance with claim 7 wherein said cylindrical rotor is made of plastic.

11. An apparatus for generating electricity comprising:
a generator for generating electricity;
a battery that is electrically connected to said generator and that is recharged by said electricity generated by said generator;
a cylindrical rotor having a longitudinal axis and a plurality of blades extending a few inches from said axis;
said blades being spirally shaped and running longitudinally in said cylindrical rotor;
said cylindrical rotor attached to said generator and adapted vertically to rotate about said axis;
a base on which said generator is attached;
a means for directing airflow or wind perpendicularly to less than all of said blades of said cylindrical rotor; and
whereby said airflow or wind pushes against less than all of said blades to rotate said cylindrical rotor causing said generator to generate electricity that recharges said battery.

12. An apparatus for generating electricity in accordance with claim 11 further comprising bearings that reduce friction during the rotation of said cylindrical rotor.

13. An apparatus for generating electricity in accordance with claim 11 wherein said cylindrical rotor is made of plastic.
